(19) United States
(12) Patent Application Publication
(10) Pub. No.: US 2021/0254868 A1
(43) Pub. Date: Aug. 19, 2021

(54) DEVICE FOR CONTROLLING THE TEMPERATURE IN AN ENCLOSURE

(71) Applicant: FAST-ENGINEERING SPRL, Isnes (BE)

(72) Inventor: Pie Olivier Atangana, Namur (BE)

(21) Appl. No.: 17/253,967

(22) PCT Filed: Jun. 20, 2019
(86) PCT No.: PCT/EP2019/066332

§ 371 Date: Dec. 18, 2020

(30) Foreign Application Priority Data
Jun. 20, 2018 (BE) 2018/5424

(51) Int. Cl. F25B 21/02; G05D 23/19

(52) U.S. Cl. CPC F25B 21/02; G05D 23/1919

(57) ABSTRACT

The invention relates to a device (1) capable of being connected to an enclosure (2), the device comprising a first portion (3) which includes a thermoelectric module (4), the module being configured to maintain the temperature inside the enclosure (2) at a set value, and wherein the device comprises a stabilising portion above the thermoelectric module (4), comprising a motorised valve (20) that operates in accordance with the temperature differential created by the thermoelectric module (4) and in accordance with the temperature outside the device so as to maintain a stable temperature differential, regardless of said temperature outside the device. A third portion of the device arranged above the stabilisation portion may comprise a heat sink (46) and one or more additional thermoelectric modules (45) configured to recover a portion of the thermal energy removed from the enclosure (2) in the event that the enclosure is refrigerated relative to a higher temperature.

### TECHNICAL FIELD

The present invention relates to the field of temperature regulation by using at least one thermoelectric module.

### BACKGROUND ART

Thermoelectric modules are well known in the state of the art. These modules exploit the Peltier effect or its opposite effect, the Seebeck effect. With regard to the Peltier effect, a heat flow is generated between two junctions of electrical conductors of different materials when an electrical current flows through the junctions. Conversely and with regard to the Seebeck effect, when the two junctions are subjected to a temperature differential, a current is generated. In practice, thermoelectric modules used in most applications comprise a series of junctions between p-type and n-type semiconductor materials, arranged between two parallel surfaces, so as to create a cold surface and a hot surface when the module is traversed by an electric current. Likewise, when a module is subjected to an outside temperature differential, it will function as an electric current generator.

The efficiency of a thermoelectric module depends largely on the difference ΔT between the temperatures of the two surfaces of the module, hereinafter referred to as the temperature differential of the module. The modules are mainly used in applications for which the temperature must be regulated in a particularly precise and reliable manner, such as, for example, for containers used for the transport of organs to be transplanted, or for applications in which the vibrations generated by conventional refrigeration systems is a major drawback that must be overcome. However, all of these applications are limited to indoor environments, for example a hospital building or a transport vehicle, where the temperature of the environment does not substantially influence the temperature differential.

In an environment with uncontrolled temperature, the use of such thermoelectric modules is more difficult, because variations in the temperature of the environment run the risk of destabilizing the temperature differential between the two thermal flow transfer surfaces of a thermoelectric module. In several cases, the influence over time of the temperature of the environment on the temperature differential cannot be overcome by simple isolation means and/or by simple regulation of the quantity of current injected into such a thermoelectric module, which makes the thermoelectric solution inapplicable in a large number of fields. These include, for example, the temporary storage of biological samples, such as blood samples, in storage boxes installed in several places, often in places liable to be subjected to significant temperature variations over time.

### SUMMARY OF THE INVENTION

The present invention aims to provide a device for controlling the temperature by exploiting known thermoelectric effects, but which does not suffer from the drawbacks described above. The basic characteristics of such a device are described in the appended claims.

The invention relates to a device capable of being placed in communication with an enclosure, the device comprising a first portion which comprises a thermoelectric module, the module being configured to maintain the temperature inside the enclosure at a set point, and in which the device comprises a stabilization portion above the thermoelectric module comprising a motorized valve which operates according to the temperature differential created by the thermoelectric module and according to the temperature outside the device, so as to maintain a stable temperature differential, independently of said outside temperature. A third portion of the device disposed above the stabilization portion may comprise a heat sink and a second thermoelectric module configured to recover part of the thermal energy discharged from the enclosure in the event that the enclosure is cooled compared to a higher temperature. According to another embodiment, the third portion comprises an air collecting chamber and the device is provided with a lateral channel which allows the passage of a direct air flow between the second chamber and the outside of the device.

In particular, the invention relates to a device for regulating the temperature in an essentially closed enclosure, said device comprising three portions:
a first portion able to be put in communication with the enclosure, the first portion comprising:
   a first thermoelectric module having a first surface and a second surface, the first module being configured to be powered by an electrical power source which is part of the device or which is outside the device,
   a first thermal transfer chamber in contact with said first surface,
   a fan for distributing conditioned air by the first surface of said first module into the enclosure,
   temperature sensors arranged on both sides of said first module,
a second portion arranged above the first portion when the device is installed in a vertical operating position, said second portion comprising a housing which comprises a second heat transfer chamber in contact with the second surface of the first thermoelectric module, the second chamber being separated by thermal insulation from the first heat transfer chamber,
a third portion arranged above the second portion when the device is installed in a vertical operating position, said third portion comprising a third chamber, and wherein:
   the second portion also comprises:
      a motorized valve configured to adjust the air convection between said second heat transfer chamber and the third chamber,
      a second fan to force an air flow between said second chamber and said third chamber, when the valve is open,
      the valve and the second fan being connected to a control unit which regulates the operation of the valve and of the second fan as a function of the temperatures measured by the temperature sensors.

According to an embodiment, the third chamber is a third heat transfer chamber, while the third portion further comprises a heat sink disposed above said third heat transfer chamber in vertical operating position of the device.

The device described in the previous paragraph may further comprise one or more additional thermoelectric modules arranged between the third heat transfer chamber and the heat sink, the additional module(s) being configured to charge a (re)chargeable power supply source.

According to an embodiment, the valve comprises a body, a jack, a seat attached to or incorporated into the box, wherein the body of the valve is a cylindrical element configured to be actuated in the vertical direction by the jack, when the device is installed in a vertical position, between an open position wherein the valve allows the passage of an airflow between the second and the third heat transfer chambers, and a closed position wherein the body of the valve is in contact with the seat of the valve, so as to block the passage of an air flow between said second and third heat transfer chambers.

In this latter embodiment, the valve body may be connected to one of the ends of a piston, the piston being configured to go up or down relative to an orifice which is incorporated in the box, the piston comprising at its second end a locking element configured to limit the path of the valve body in the vertical direction, when the device is installed in a vertical position.

According to an embodiment, the third heat transfer chamber is provided with depressurization vents.

According to an embodiment, an upper portion (in vertical operating position of the device) of the third heat transfer chamber is formed by an element made of a material of high thermal conductivity, said element having the shape of a cup which is open towards the bottom, the bottom of the cup forming the ceiling of the third chamber, and wherein the thickness of the bottom of the cup is less than the thickness of the lateral walls of the cup, and wherein said bottom is in thermally conductive contact with the heat sink, or—where applicable—with the additional thermoelectric module(s).

According to another embodiment:
the third portion comprises an opening which allows the entry of air from outside the device into the third chamber,
the valve comprises a body, a jack, a seat attached to or incorporated in the box, while the valve body is an element configured to be actuated by the jack, between an open position and a closed position,
the box comprises a lateral channel connected to the outside of the device,
the valve is configured such that:
   when the valve is open, the second heat transfer chamber is connected to the lateral channel, allowing the passage of an air flow from the second chamber to the lateral channel and from there to the outside of the device,
   when the valve is closed, the connection between the second chamber and the lateral channel is blocked,
   regardless of the open or closed state of the valve, the lateral channel is separated from the third chamber.

In the embodiment of the previous paragraph, the valve may comprise a rod provided with seals at both ends, and the rod and the box may be configured such that:
when the valve is open, the first seal blocks a first air connection between the lateral channel and the third chamber,
when the valve is closed, the first seal blocks a second air connection between the second heat transfer chamber and the lateral channel, and the second seal blocks the first air connection between the lateral channel and the third chamber.

In the device according to the previous two paragraphs, the second heat transfer chamber may comprise a heat sink mounted on the second surface of the first thermoelectric module, the second fan being mounted on the heat sink. The second heat transfer chamber may further comprise a peripheral channel which is connected to the lateral channel when the valve is open.

According to an embodiment, the first heat transfer chamber comprises a wall of conical or symmetrically curved shape, the top of said surface being oriented upwards (in vertical operating position of the device), an orifice being provided in the middle of said conical or curved wall, the surface being connected to the lateral walls of said first chamber so that the conical or curved wall may collect water formed by condensation.

The conical or curved wall may be formed from a heat insulating material.

According to one embodiment, the first portion comprises a box, wherein the first thermoelectric module is provided with one or more thermal insulation joints between the box and the first module.

The device may comprise a cover which surrounds the box of the second portion and which is attached to the box of the first portion, the cover also comprising in its interior at least a portion of the third chamber.

According to an embodiment, the device according to the invention is provided with means for reversing the polarity of the power supply of the first thermoelectric module.

### BRIEF DESCRIPTION OF THE FIGURES

FIG. 1 shows a device according to a first embodiment of the invention in 3D view.

FIG. 2 shows several plan views and sectional views of the device of FIG. 1.

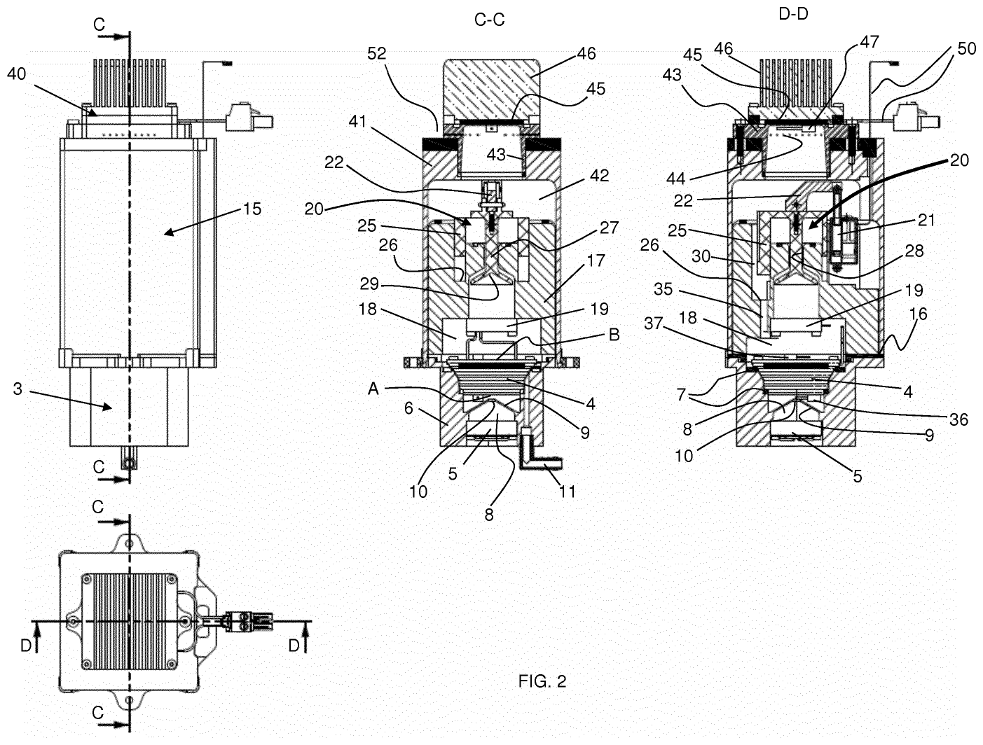

FIG. 3 represents a view of the components of the box which form part of the stabilization portion of the device according to the first embodiment of the invention.

FIG. 4 is an illustration of the operation of the valve which is part of the stabilization portion of a device according to the first embodiment of the invention.

FIG. 5 shows a detail of the device shown in FIGS. 1 to 4.

FIGS. 6a and 6b respectively show a 3D view and a side view of the exterior of the device according to a second embodiment.

FIGS. 7a and 7b show sections along the plane A-A shown in FIG. 6b, in two different states of the device.

FIG. 8 shows an exploded view of the stabilization portion of the device according to the second embodiment.

FIG. 9 shows an exploded view of the motorized valve of the device according to the second embodiment.

### DETAILED DESCRIPTION OF AN EMBODIMENT OF THE INVENTION

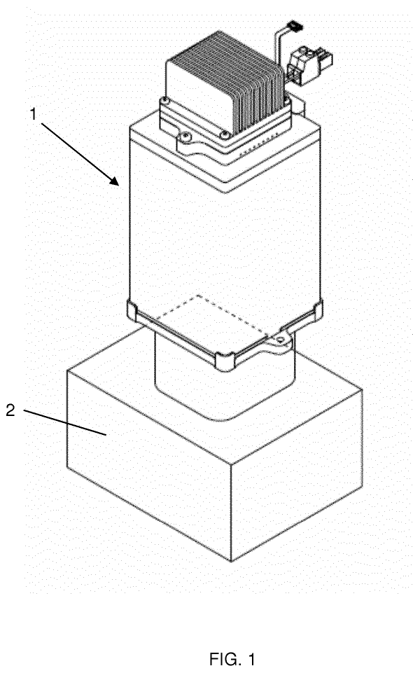

The device shown in the various figures is a device according to preferred but non-limiting embodiments of the invention, the invention being limited only by the appended claims. The device 1 as shown in FIG. 1 is arranged on an enclosure 2 in which the temperature must be maintained. The operation of the device will first be described on the basis of a current situation, according to which the interior of the enclosure 2 is maintained at a temperature lower than the temperature outside the device. For example, in a temporary storage box for biological samples, the temperature inside the enclosure 2 may need to be maintained at a set point of 5° C., regardless of the outside temperature, which may vary between 10° and 30° over a 24 hour period.

The device comprises three portions, arranged successively in the vertical direction, when the device is installed vertically, i.e. above the refrigerated enclosure 2 as is the case in FIG. 1. It should be noted that the operating position of the device is not limited to this vertical installation. The device may also be inclined or mounted horizontally on an inclined or vertical wall of an enclosure, for example. The detailed description will nevertheless be based on the case of the vertical installation illustrated in FIG. 1. At the bottom of the device is a first portion 3, called the thermoelectric portion, and which comprises a thermoelectric module 4 as is known per se. In the preferred form of the device shown in the figures, a thermoelectric module 4 of the CPM-2F type, marketed by the company CUI Inc., is used. When it is powered by an electric current generated by a battery or by the network, the module 4 generates a temperature differential between the cold surface A of the module and the hot surface B of the module. A fan 5 distributes the air cooled by the module 4 into the enclosure 2 through an opening provided in a wall of the enclosure 2. The module 4 is arranged in a box 6 with thermal insulation gaskets 7 arranged between the module 4 and the box material 6. Underneath the thermoelectric module 4, between the cold surface A and the fan 5, is a heat transfer chamber 8.

The module 4 and the fan 5 are controlled by a first control loop which will activate the module and the fan to reach and maintain a set temperature in the enclosure 2. The module 4 and the fan 5 operate in on/off mode according to a measurement of the temperature of the enclosure 2 by a temperature sensor placed in the enclosure and/or according to a measurement of the surface A of the module by a sensor 36 mounted on said surface A.

According to the preferred embodiment, the chamber 8 comprises a wall 9 of conical or symmetrically curved shape (for example parabolic), the apex of which is oriented upwards and is provided with a central orifice 10. The wall 9 is attached to the lateral walls of the chamber 8 so as to be able to capture the condensation formed by the refrigeration effect, while allowing heat transfer through the central orifice 10, when the module 4 is activated.

According to a preferred embodiment, the wall 9 is made of a thermally insulating material. When module 4 is not activated, said wall 9 and surface A of said module 4 thus form an antechamber which voluntarily limits heat transfers between the antechamber and chamber 8 via the orifice 10, the surface of which is strictly less than the surface A of module 4. This allows to reduce the influence of temperature variations of the enclosure 2 on surface A of module 4 and improves the stability of the temperature differential between surfaces A and B of module 4.

Channels (not visible in the figures) may be provided inside the box 6 to allow the evacuation of the condensation by gravity towards an evacuation nozzle 11. Other not-shown channels are provided to allow air circulation between the cooled enclosure and the heat transfer chamber 8. The channels for the condensate discharge as well as the nozzle 11 are, in fact, optional, since the volume of the condensate is normally quite small, and the air circulation will carry away the condensate drops that are formed.

According to a preferred embodiment, there is an discharge space, for example about 0.5 mm thick, between the outer lateral surfaces of the thermoelectric module 4 and the walls of the cavity of the box 6 in which the thermoelectric module is housed and the channel of the nozzle 11 is connected to the discharge space. The entirety of this internal channel is sealed up to the outlet of the nozzle 11 and forms a natural discharge circuit for the condensation formed on the outer side surfaces of the thermoelectric module 4. According to the same embodiment, said discharge space of for example 0.5 mm thick constitutes a natural thermal insulation between the outer lateral walls of the thermoelectric module 4 and the walls of the cavity of the box 6 in which the thermoelectric module is housed. Said thermal insulation is obtained by the thermal resistance of the air layer present in said discharge space. According to the same embodiment, said discharge space limits the contact surface between the outer lateral walls of the thermoelectric module 4 and the walls of the cavity of the box 6 to allow a single contact at the sealing points formed by the thermal insulation seals 7.

The thermal energy transferred from the cold surface A to the hot surface B of the thermoelectric module 4 must be evacuated to maintain the temperature differential at a stable level of about 30° C., for example, regardless of the temperature outside the device. In the device of the invention, this evacuation is actively controlled by means of the second portion of the device, called the stabilization portion 15, and located above the thermoelectric portion 3, a thermal insulation seal 16 being arranged between the thermoelectric portion 3 and the stabilization portion 15. The stabilization portion 15 comprises a box 17 which firstly comprises a second heat transfer chamber 18, the lower surface of which largely corresponds with the hot surface B of the thermoelectric module 4. The chamber 18 is thermally insulated from the chamber 8. This feature is achieved by the seals 7 and 16, and, preferably, also by the air space of, for example, 0.5 mm described above, and by using a module 4 as shown in the figures, having a significant thickness between the surface A and the surface B. The fact of properly insulating the chambers 8 and 18 from each other will contribute significantly to the stability of the ΔT.

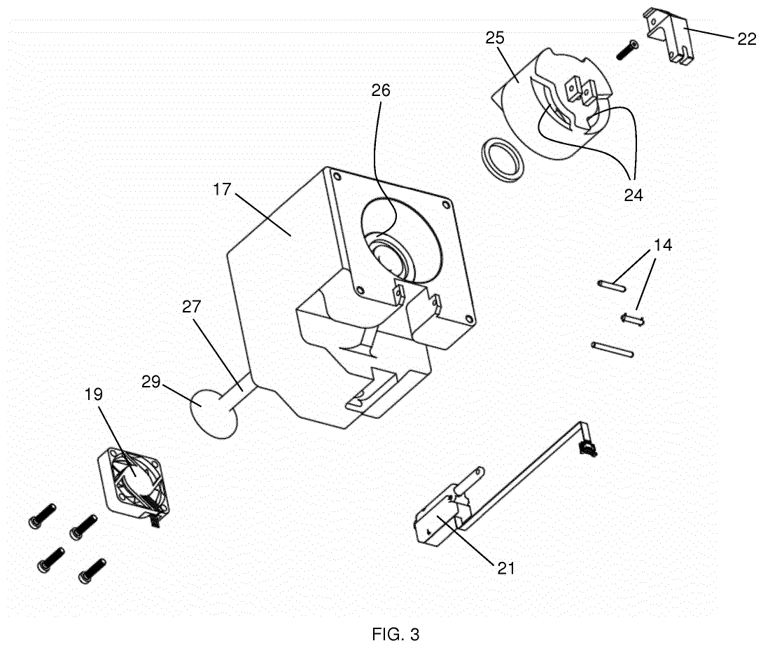

The chamber 18 comprises a second fan 19 configured to accelerate the convection of hot air upwards. A motorized valve 20 is arranged above the second heat transfer chamber 18 and is controlled by an electric actuator 21 via a connecting rod 22. The components of the stabilization portion 15 are shown in more detail in FIG. 3. The body 25 of the valve is an essentially cylindrical element which is movable in the vertical direction by the actuation of the jack 21 which will pull or push the connecting rod. A series of pins 14 is provided for assembling the jack, the connecting rod and the body 25 of the valve. The seat 26 of the valve is formed by an annular space inside the box 17. The seat may be machined in the box or it may consist of a portion attached to the box. The valve body is provided with openings 24 to allow air circulation between the space 42 above the valve (described later in more detail) and the heat transfer chamber 18 via a central channel 23 provided in the box 17 above the second fan 19 and via the hole(s) 35 and the connection 30, when the valve is open (see later for more details). The valve body 25 is connected to the first end of a piston 27 guided by a cylindrical orifice 28, the piston comprising a locking element 29 at its second end which restricts movement of the valve body 25 in the vertical direction. Actually, the element 29 is optional. When the control of the action of the jack 21 is precise enough to allow precise positioning of the valve 20, the locking element 29 may be removed. The two boxes 6 and 17 are formed from a material having low thermal conductivity, and preferably also having low electrical conductivity. According to a preferred embodiment, these materials are thermoplastics with an amorphous and/or thermosetting structure thanks to their high mechanical resistance to concentrated temperatures and, on the other hand, thanks to their low thermal conductivity compared to thermally conductive materials such as steel.

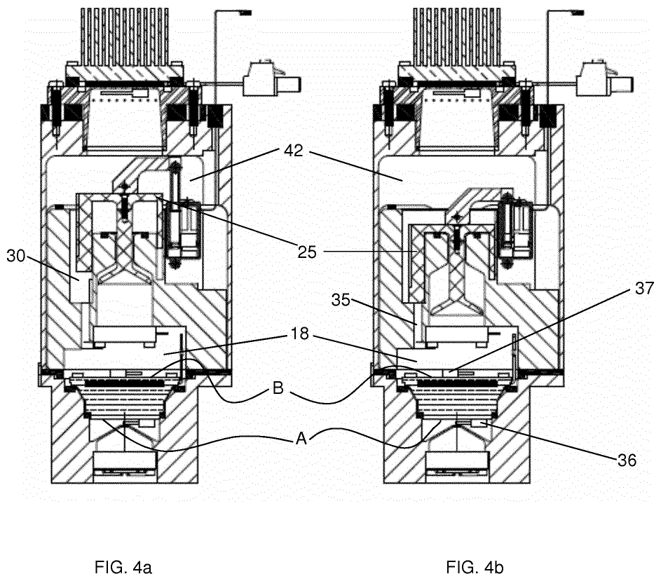

FIG. 4 shows the ‘open valve’ and ‘closed valve’ positions of the device. When the valve 20 is raised (open position) (FIG. 4a), always in the case when the set temperature is lower than the temperature outside the device, the hot air may move towards the top of the device, for example via one or more eccentric orifices 35 provided in the box 17 of the stabilization portion 15 and by the connection 30 between the body of the valve 25 and the seat of the valve 26. In the closed position of the valve 20 (see FIG. 4b), the air convection path is blocked. The operation of the valve 20, preferably synchronized with the operation of the fan 19, is automatically adjusted on the basis of the direct measurement of the temperature differential by two temperature sensors 36 and 37 arranged respectively on the cold surface A and the hot surface B of the thermoelectric module 4.

The valve 20 is controlled by a second control loop, which actuates the opening of the valve when the ΔT measured by the sensors 36 and 37 exceeds a set value, for example 30° C. The second control loop may be a PI loop or any other loop known in the prior art (P, I, PID, etc.). The regulation is preferably based on a range of values around the set point or a percentage of the set point. At the start of operation of the device, the valve 20 is closed. Module 4 and fan 5 are activated, which leads to a drop in temperature of the cold surface A and an increase in temperature of the hot surface B. When the hot surface B of the module exceeds a value or a range of relative values relative to the cold surface A, defined such that this overshoot leads to a situation of excessive ΔT differential, the valve opens and the fan 19 is activated, preferably at a constant and predefined speed, thus creating a flow of hot air towards the top of the device, through the hole(s) 35 and through the connection 30 between the body of the valve 25 and the seat of the valve 26. Other modes of operation could provide for a change in the speed of the fan 19 according to the difference between the measured ΔT and the set point for this ΔT. When the ΔT enters a range of acceptable values, the valve 20 closes again.

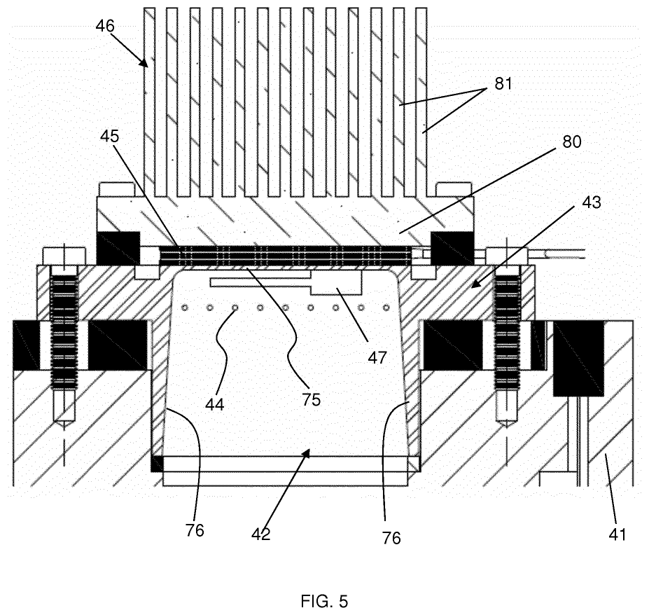

Finally, above the stabilization portion 15 is a third portion 40, called the dissipation portion of the device. Preferably, the dissipation portion is located inside a cover 41 which surrounds the box 17 of the stabilization portion 15 and which is attached to the box 6 of the thermoelectric portion 3 by screws and/or clip systems. The dissipation portion 40 comprises a third heat transfer chamber 42 including a lower portion in direct communication with the eccentric hole(s) 35 and the cylindrical orifice 28 towards the second heat transfer chamber 18, and an upper portion which forms the internal space of a part 43, named heat concentrator, which has the shape of a cup partially encapsulated by the material of the cover 41. The concentrator 43 is preferably made of a highly thermally conductive material such as copper. The concentrator 43 is open at the bottom and closed at the top. As shown in FIG. 5, the ceiling of the third heat transfer chamber 42 is formed by the bottom 75 of the concentrator cup. The thickness of the bottom 75 is less than the thickness of the lateral walls 76 of the concentrator. This structure results in a functionality of the concentrator which is advantageous for heat removal from the chamber 42. The heat discharged from the second chamber 18 when the valve 20 is open must then be rapidly discharged to the outside to ensure the stability of ΔT on the module 4. The concentrator 43 will stimulate this transfer of thermal energy by rapidly heating the bottom 75 of the concentrator. In addition, this bottom is in thermally conductive contact with a second thermoelectric module 45. Preferably, the contact between these components is made even more thermally conductive by the application of a thermal paste between the upper surface of the bottom 75 and the lower surface of the module 45. Above module 45 and in thermal contact with the latter, the device further comprises a heat sink 46, comprising a base 80 and a row of lamellae 81 (see FIG. 5). This heat sink structure is known and is not limiting. Other known heat sink structures may be used.

The second module 45 may operate as an electric current generator by exploiting the Seebeck effect, thanks to the gradual increase of the temperature in the chamber 42 and thanks to the temperature differential between the underside of the module 45 being in contact with the concentrator 43 and the upper surface of said module 45 being in contact with the heat sink 46. To this end, the second module 45 is connected, for example, to a rechargeable battery (not shown) which contributes to the power supply of the first module 4 and/or other electrical components integrated into the device.

A temperature sensor 47 is arranged on the underside of the second module 45. A second temperature sensor (not shown) is housed in the base 80 of the heat sink 46, so as to measure the temperature on the other side of the module 45, i.e. so as to measure the ΔT on said module 45. A third control loop is provided to regulate the operation of the module 45: when the ΔT exceeds a threshold, the module will be connected to a rechargeable battery.

According to another embodiment, the dissipation portion 40 does not include the second module 45, but includes the heat sink 46. In this case, there is a direct thermally conductive contact between the bottom 75 of the concentrator 43 and the heat sink base 46.

According to another form, the device does not comprise the concentrator 43, but the chamber 42 is entirely surrounded laterally by the non-thermally conductive material of the cover 41. The heat transfer in this case is carried out entirely by air convection in the chamber 42 and by thermal conduction in the base 80 and the lamellae 81 (or equivalent) of the heat sink 46. It is clear that the heat removal in this case will be less efficient, but this defect could be compensated by an adapted sizing of the chamber 42 and/or of the heat sink 46.

The device is preferably provided with a number of vents 44 in the second heat transfer chamber 42. These are openings of reduced section to the outside of the device, which are provided in the lateral wall of the concentrator 43 in the embodiment shown in the figures. The presence of the vents 44 effects a depressurization of the chamber 42 when the pressure in this chamber reaches an excessive level, so as to maintain the pressure in this chamber at an acceptable level. Preferably, pressure sensors are also provided: a first sensor may be mounted at the level of the sensor 47 (or this sensor may be a temperature and pressure sensor). A second pressure sensor may be mounted between the lamellae of the heat sink 46. These sensors allow to monitor the pressure difference between the chamber 42 and the environment.

Furthermore, the device is provided with channels and/or openings for the passage of electric cables 50 necessary to supply the various components of the device 1.

The device 1 is also provided with a control unit, or, alternatively, the device may be connected to a control unit which is located outside the device, the unit being configured to acquire signals representing the temperatures and—where applicable—pressures measured by the various sensors. The control unit also allows to generate control signals based on the measured values. The various control loops described above are therefore implemented through this control unit. The precise implementation in terms of electrical and electronic components of the control unit is not described in detail here since this implementation falls within the competence of those skilled in the art in the field of air conditioning.

According to an embodiment, said control unit is provided with communication means of various radio frequency types (example: RFID), for example for the identification and access management of biological samples stored in the enclosure 2.

Said control unit may also be provided with a, preferably wireless, telecommunication module (example: 3G/4G/5G) to allow connection and transmission of information relating to the regulation of temperatures, the states of operation of the device 1 and of said control unit, towards at least one user interface and to at least one computer data server via a cloud computing system.

Instead of providing a single thermoelectric module 45 in the dissipation portion 40 of the device, several modules 45 may be provided, for example positioned in a single plane. In this case, a concentrator 43 may be considered with the bottom 75 extending beyond the periphery of the lateral walls 76. The bottom thus becomes a platform on which several (rows of) modules 45 are mounted. The multiplication of the modules 45 increases the capacity of the device to recover thermal energy in the form of electric current.

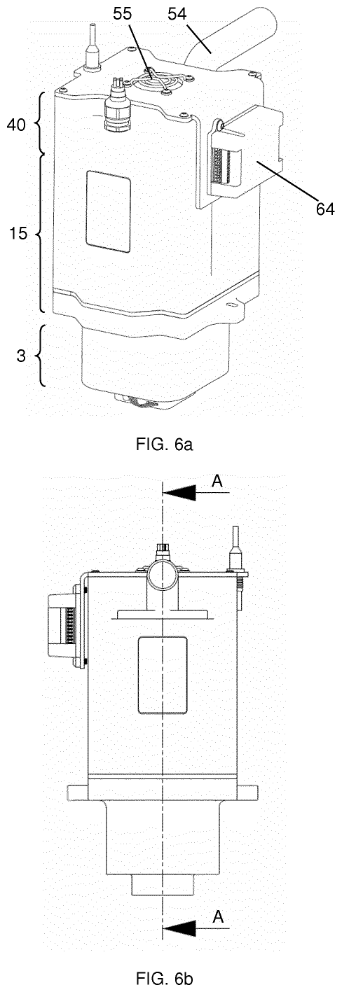

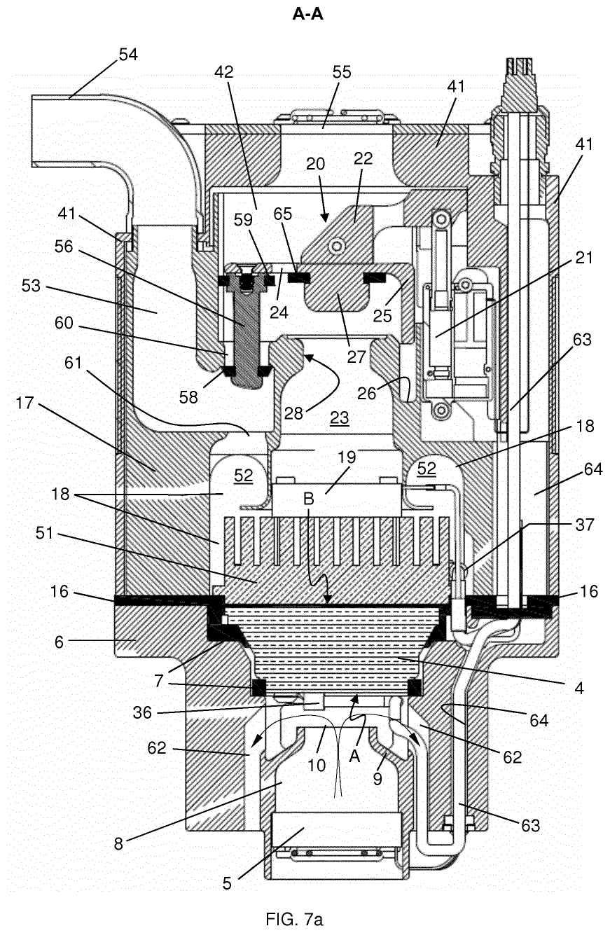

A second embodiment of a device according to the invention is shown in FIGS. 6 to 9. The operation of the device is again described for the case wherein the device cools an enclosure on which it is mounted in a vertical position. Again, it should be noted that other orientations of the device are possible and that the invention is not limited to vertical installation. A number of compartment elements are recognized, numbered by the same numerical references as for the first embodiment, in particular the thermoelectric module 4 having a cold surface A and a hot surface B. The first portion 3 (thermoelectric portion) of the device is also visible, comprising the box 6, the thermal insulation seals 7, the first heat transfer chamber 8, the first fan 5, as well as the temperature sensors 36 and 37. The stabilization portion 15 is again arranged above the first portion 3. This stabilization portion 15 comprises the box 17, the second heat transfer chamber 18, isolated from the first chamber 8 by seals 16, and the central channel 23 above the second fan 19, as well as the motorized valve 20. FIGS. 7a and 7c respectively represent the “valve open” and “valve closed” situations.

Specifically for this embodiment, a lamellar heat sink 51 is mounted in the second chamber 18. The heat sink 51 is in thermal contact with the hot surface B of the module 4. The second fan 19 is mounted on the heat sink 51. The chamber 18 further comprises a peripheral channel 52 disposed around the fan 19. The peripheral channel 52 is connectable to a lateral channel 53 (described in more detail later) provided in the box 17, and connected by a nozzle 54 outside the device. The third portion 40 of the device comprises the third chamber 42. As in the first embodiment, the portion 40 is produced by a cover 41 which surrounds the box 17 of the stabilization portion 15 and which is attached to the box 6 of the thermoelectric portion 3 by screws and/or clip systems.

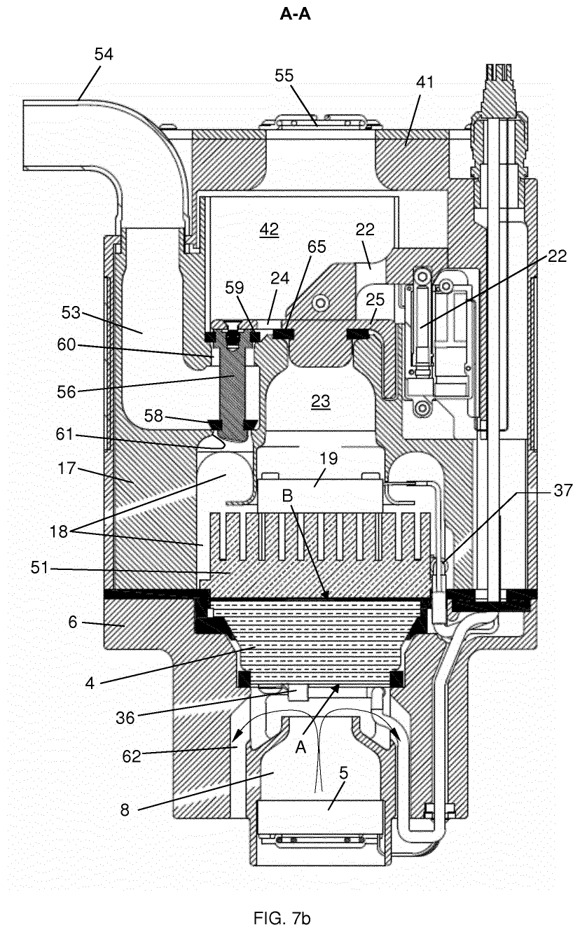

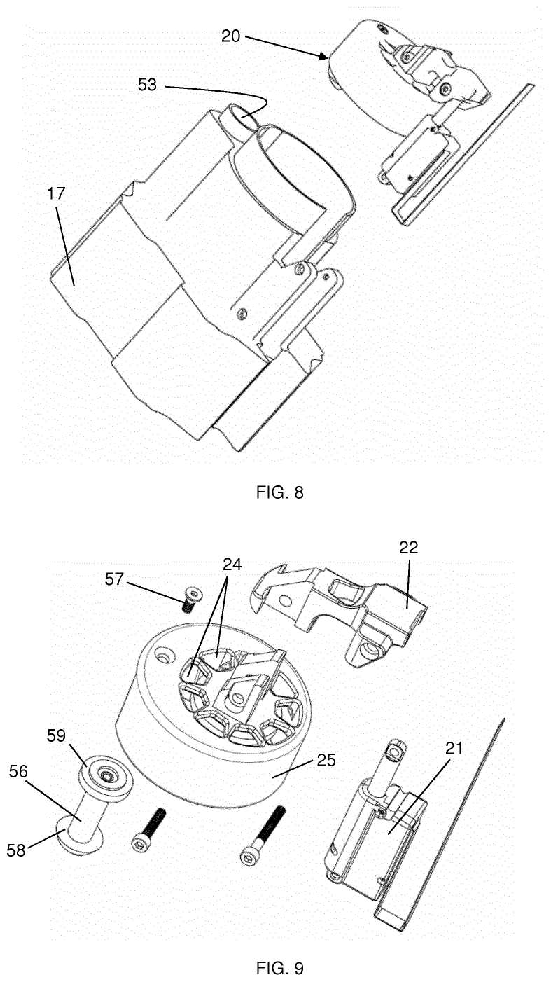

Unlike the first embodiment, the device shown in FIGS. 6 and 7 does not comprise a heat sink above the third chamber 42, or a thermoelectric module for recovering of energy. An opening 55 which allows the entry of air from the outside into the device is provided above the third chamber 42. This chamber 42 is in this case rather an air collecting chamber than a heat transfer chamber. The heat transfer takes place entirely in the chambers 8 and 18, and the heat removal is separated from the third portion 40. To this end, the motorized valve 20 is configured in a slightly different way compared to the first embodiment. An exploded view of the stabilization portion 15 according to this second form is shown in FIG. 8, and an exploded view of the valve itself is shown in FIG. 9. The valve 20 still comprises a body 25 provided with openings 24 to allow the circulation of air actuated by the second fan 19. The movement of the body 25 of the valve is actuated as in the other embodiment, by a jack 21 and a connecting rod 22. We also see the seat 26 of the valve, and the part 27 which moves like a piston in the cylindrical hole 28 provided in the box 17.

Unlike the first embodiment, the piston 27 is not provided with a locking element, the positioning of the valve being fully adjusted by the actuator 21. A seal 65 blocks the air flow from the third chamber 42 to the second chamber 18 when the valve is closed (FIG. 7b). The valve body 25 further comprises an eccentric portion which supports a rod 56 integrated into the valve body. In FIG. 9, it may be seen that the rod 56 is attached to the body 25 of the valve by a screw connection 57. The rod 56 is provided with seals 58 and 59 at its two ends. The first seal 58, attached to the lower end of the rod, is a double acting seal. The upper surface of the seal 58 is configured to block the connection 60 between the lateral channel 53 and the third chamber 42, when the valve 20 is open (FIG. 7a). When the valve is closed (FIG. 7b), the underside of the second seal 59 will block this same connection 60, while the underside of the seal 58 blocks the connection 61 between the chamber 18 and the lateral channel 53.

In the first portion 3 of the device, the box 6 is provided with a peripheral channel 62 connected to the first chamber 8, which allows the circulation of air actuated by the first fan 5. Preferably, the air is circulated in the direction indicated by the arrows, but the reverse direction is also possible. The wall 9 is still present, but this wall is now integrated in the box 6, and the orifice 10 is wider. In this embodiment, the wall 9 does not have the function of creating an antechamber. The electric cables 63 for powering the module 4, the fans 5 and 19 and the temperature sensors 36 and 37 are guided in openings 64 integrated in the box 6 and in the cover 41.

The regulation of the temperature in an enclosure by the device is performed in the same way as for the first embodiment, by means of a control unit which may be integrated into the device. In the latter case, the control unit 64 is visible in FIG. 6a. In cooling mode, the cold air created in contact with the surface A of the thermoelectric module 4 is transported into the enclosure by the fan 5. In the meantime, the temperature of the hot surface B increases, as does the temperature in the chamber 18 which is at this moment separated from the chamber 42 and the lateral channel 53 by the closed valve 20 (FIG. 7b). When the temperature differential, measured by sensors 36 and 37, exceeds a predefined threshold, the valve 20 opens and the second fan 19 is activated. The opening of the valve means that the valve instantly switches to the state shown in FIG. 7a, i.e. the state in which the seal 58 blocks the connection 60 between the lateral channel 53 and the chamber 42, but opens the connection 61 from the chamber 18 to the lateral channel 53. Air is drawn through openings 24 in the valve body 25, and flows through the lamellae of the heat sink 51, where the air is heated. The hot air is then guided by the peripheral channel 52 towards the lateral channel 53 which is accessible thanks to the position of the rod 56, and is discharged to the outside through the nozzle 54. When the temperature differential falls below the preset threshold, the valve closes.

The device of FIGS. 6 to 9 may also operate without the presence of a heat sink 51, although the heat transfer is less efficient. The rod 56 is only one example of a mechanism which performs the function of configuring the valve such as:
when the valve is open, the second heat transfer chamber 18 is connected to the lateral channel 53, allowing an air flow from the second chamber 18 to the lateral channel 53 and from there to the outside of the device,
when the valve is closed, the connection between the second chamber 18 and the lateral channel 53 is blocked,
regardless of the open or closed state of the valve, the lateral channel 53 is separated from the third chamber 42.

Preferably, the device of the invention not only operates in refrigeration mode but it may also heat the enclosure 2 to maintain the set temperature in the enclosure when the outside temperature drops below a certain level. To this end, the device is configured to reverse the polarity of the power supply of module 4 when necessary. For example, we may have a scenario where the temperature outside gradually drops from a level of 35° C. to a level of −10° C. in 2 or 3 hours while the temperature in the enclosure 2 must be maintained at ±5° C.

At the beginning of this period, the temperature in the chamber 18 will be maintained at approximately 35° C., to ensure a ΔT of approximately 30° C. on the module 4. When the temperature drops, this maintenance at 35° C. in the chamber 18 will be provided by regulating the valve 20 and the fan 19 as described above. At one point, the temperature outside the device has become so low that the temperature in chamber 18 begins to decrease, resulting in a drop in temperature in chamber 2 below the set point. When this temperature (for example detected, via the sensor 36) drops below a predefined value (e.g. below a range around the set point), the polarity of module 4 will be reversed and module 4 starts to heat the enclosure. A ΔT on the module 4 may again be maintained in the heating regime by the action of the valve 20.

The use of a device according to the invention extends to all the technical fields which require the air conditioning of an enclosure 2. In particular, the device may be used in a storage box for biological samples in which a user deposits the samples, which are then collected from the box at a later time. The device makes it possible to air-condition an enclosure inside the box in which the samples are stored and to maintain the samples at a set temperature. The device may also be used in more general air conditioning applications, for example as an alternative to a compressor in a conventional refrigerator.

1. A device for regulating the temperature in a closed chamber, said device comprising three portions:
a first portion capable of being placed in communication with the enclosure, the first portion comprising:
a first thermoelectric module having a first surface (A) and a second surface (B), the first module being configured to be powered by an electrical power source which is part of the device or which is outside the device,
a first heat transfer chamber in contact with said first surface (A),
a fan to distribute conditioned air by the first surface (A) of said first module into the enclosure,
temperature sensors arranged on both sides (A, B) of said first module
a second portion provided above the first portion when the device is installed in a vertical operating position, said second portion comprising a box which comprises a second heat transfer chamber in contact with the second surface (B) of the first thermoelectric module, the second chamber being separated by a thermal insulation from the first heat transfer chamber,
a third portion provided above the second portion when the device is installed in a vertical operating position, said third portion comprising a third chamber, and wherein:
the second portion also comprises:
a motorized valve configured to adjust the convection of air between said second heat transfer chamber and the third chamber,
a second fan for forcing an air flow between said second chamber and said third chamber when the valve is open,
the valve and the second fan being connected to a control unit which regulates the operation of the valve and of the second according to the temperatures measured by the temperature sensors.

2. The device according to claim 1, wherein the third chamber is a third heat transfer chamber, and wherein the third portion further comprises a heat sink provided above said third heat transfer chamber in vertical operating position of the device.

3. The device according to claim 2, further comprising one or more additional thermoelectric modules arranged between the third heat transfer chamber and the heat sink, the additional module(s) being configured to charge a (re)chargeable power supply source.

4. The device according to claim 2, wherein the valve comprises a body, a jack, a seat attached to or incorporated in the box, and wherein the valve body is a cylindrical element configured to be actuated in the vertical direction by the jack, when the device is installed in vertical position, between an open position wherein the valve allows passage of an air flow between the second and the third heat transfer chambers, and a closed position wherein the valve body is in contact with the valve seat, so as to block the passage of an air flow between said second and third heat transfer chambers.

5. The device according to claim 4, wherein the body of the valve is connected to one end of a piston, the piston being configured to move up or down relative to an orifice which is incorporated in the box, the piston comprising at its second end a locking element configured to limit the path of the body of the valve in a vertical direction when the device is installed in vertical position.

6. The device according to claim 2, wherein the third heat transfer chamber is provided with depressurization vents.

7. The device according to claim 2, wherein an upper portion (in vertical operating position of the device) of the third heat transfer chamber is formed by an element made of a material of high thermal conductivity, said element having the form of a cup which is open downwards, the bottom of the cup forming the ceiling of the third chamber, and wherein the thickness of the bottom of the cup is less than the thickness of the lateral walls of the cup, and wherein said bottom is in thermally conductive contact with the heat sink, or, where appropriate, with the additional thermoelectric module.

8. The device according to claim 1, wherein:
the third portion comprises an opening which allows the entry of air from outside the device into the third chamber,
the valve comprises a body, a jack, a seat attached to or incorporated in the box, the valve body being an element configured to be actuated by the jack between an open position and a closed position,
the box comprises a lateral channel connected to the outside of the device,
the valve is configured such that:
when the valve is open, the second heat transfer chamber is connected to the lateral channel, allowing passage of an air flow from the second chamber to the lateral channel and from there to the outside of the device,
when the valve is closed, the connection between the second chamber and the lateral channel is blocked,
regardless of the open or closed state of the valve, the lateral channel is separated from the third chamber.

9. The device according to claim 8, wherein the valve comprises a rod provided with seals at its two ends, and wherein the rod and the box are so configured that:
when the valve is open, the first seal blocks a first air connection between the lateral channel and the third chamber,
when the valve is closed, the first seal blocks a second air connection between the second heat transfer chamber and the lateral channel, and the second seal blocks the first air connection between the lateral channel and the third chamber.

10. The device according to claim 8, wherein the second heat transfer chamber comprises a heat sink mounted on the second surface (B) of the first thermoelectric module and wherein the second fan is mounted on the heat sink.

11. The device according to claim 10, wherein the second heat transfer chamber further comprises a peripheral channel which is connected to the lateral channel when the valve is open.

12. The device according to claim 1, wherein the first heat transfer chamber comprises a wall of conical or symmetrically curved shape, the top of said surface being oriented upwards (in vertical operating position of the device), an orifice being provided in the middle of said conical or curved wall, the surface being connected to the lateral walls of said first chamber so that the conical or curved wall may collect water formed by condensation.

13. The device according to claim 12, wherein the conical or curved wall is formed of a heat insulating material.

14. The device according to claim 1, wherein the first portion comprises a box wherein the first thermoelectric module is provided with one or more thermal insulation seals between the box and the first module.

15. The device according to claim 14, wherein the device comprises a cover which surrounds the box of the second portion and which is attached to the box of the first portion, the cover also comprising in its interior at least a portion of the third chamber.

16. The device according to claim 1, provided with means for reversing the polarity of the power supply of the first thermoelectric module.
